(19) United States
(12) Patent Application Publication
(10) Pub. No.: US 2012/0229971 A1
(43) Pub. Date: Sep. 13, 2012

(54) INFORMATION HANDLING SYSTEM SHARED INFRASTRUCTURE CHASSIS WITH FLEXIBLE DEPTH

(76) Inventors: Richard Steven Mills, Cedar Park, TX (US); German Florez-Larrahondo, Georgetown, TX (US); Jimmy D. Pike, Georgetown, TX (US); John Stuewe, Round Rock, TX (US); Joseph M. Sekel, Austin, TX (US)

(21) Appl. No.: 13/044,928

(22) Filed: Mar. 10, 2011

(51) Int. Cl. G06F 1/20; G06F 1/16

(52) U.S. Cl. 361/679.46; 361/679.02

(57) ABSTRACT

An information handling system tray component is selected for a depth to fit into chassis support components to provide processing resources in a space having different depths. An end user selects a chassis component having a depth that fits a data center and then installs tray components into the chassis component by selecting the tray component depths to fit in that of the chassis component. The tray component supports different processing components depending upon the selected depth so that information handling system features are adapted to chassis depth while using a common infrastructure component.

### BACKGROUND OF THE INVENTION

1. Field of the Invention

The present invention relates in general to the field of information handling system chassis, and more particularly to information handling system shared infrastructure chassis with flexible depth.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Large enterprises depend upon information handling systems to perform a number of vital functions, from supporting internal employee operations to public sales. Often, large enterprises have specialized information technology groups that manage information handling system operations. Information technology administrators are typically tasked with maintaining enterprise server information handling system data centers where banks of server information handling system racks operate to support enterprise operations. Each server information handling system rack supports multiple information handling systems with access to power and cooling resources. Over time, many large enterprises have built multiple data centers distributed around the world to provide local resources for customers and employees and to provide redundancy in the event of disruptions that might occur at particular locations, such as power outages due to natural disasters. Most data centers have similar structures that are designed to provide power and cooling to information handling systems, however, the specific power and cooling capabilities of a data center often vary depending upon when and where the data center was built. For example, power consumption of processing components has tended to grow over time with increased processing capability of the processing components, so older data centers tend to support less power per unit area than newer locations.

Variations in data center capability present information handling system manufacturers with difficult design choices. One choice is to maximize the amount of components that can fit in an information handling system with a very deep and power hungry solution that needs a deep server rack and dense cooling, however this limits design to use in only the newest data centers. Another choice is to design an information handling system to fit in the smallest data center, however, this limits product features and typically results in reduced sales to newer data centers because it leaves expensive data center capability unused. Another choice is to develop new information handling systems around specific depth requirements of each individual customer, however, individual designs for specific customers are generally cost prohibitive. Some limited ability does exist to adapt a given chassis to different usable depths, such as by using an adjustable EIA flange or by cutting an extrusion to length and filling in wall lengths. One example is the DELL 4220 and 4820 racks, which use common internal components with EIA flanges cut to either 42 U or 48 U tall and fills empty space with doors and structural pieces. The limited adaptability provided in this manner comes with considerable complexity and cost.

### SUMMARY OF THE INVENTION

Therefore a need has arisen for a system and method which provides a chassis having a shared infrastructure that supports a factory configurable depth.

In accordance with the present invention, a system and method are provided which substantially reduce the disadvantages and problems associated with previous methods and systems for adjusting a chassis to accept different amounts of processing components. A tray component adjusts in depth to fit in chassis support components having different depths. The tray component is configured with processing components based on space available for a selected depth.

More specifically, a data center determines the depth available for a server rack based on available space or other factors. A chassis support component having plural slots, each slot having an appropriate depth, is selected from plural chassis support components of plural different depth. A tray component for each of plural slots is selected from between selectable depths to a depth that fits within the chassis component slot depth. For example, overlapping support bases are slid relative to each other to adjust the tray component depth and then locked in place with a screw. The tray component is populated with processing components that will fit into selected depth, such as processing components that support a server or a storage function. An infrastructure component couples to the chassis support component in the slot proximate the tray component to provide power, cooling or other infrastructure functions.

The present invention provides a number of important technical advantages. One example of an important technical advantage is that an end user's information handling system features are optimized around the depth that the end user has available in a data center. Adjustable chassis depth provides a low cost solution using a common basic architecture for multiple depths. Infrastructure components need only be engineered once in order to support multiple configurations and depth. Design and manufacture costs are reduced while flexibility is increased for meeting specific customer needs as defined by existing data center cooling and power infrastructure capabilities.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a front view of a server rack information handling system that supports plural information handling systems disposed in slots;

FIG. 2 depicts a side breakaway view of a server rack information handling systems that supports tray components of different depths;

FIG. 3 depicts a top view of tray components of different depths;

FIG. 4 depicts a tray component that having overlapping support bases that slide relative to each other; and

FIG. 5 depicts a side perspective view of an infrastructure component.

### DETAILED DESCRIPTION

A server rack adapts to different depths by positioning an infrastructure component relative to a processing tray of a selected depth with different sized processing trays provide information handling systems of varying capability. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

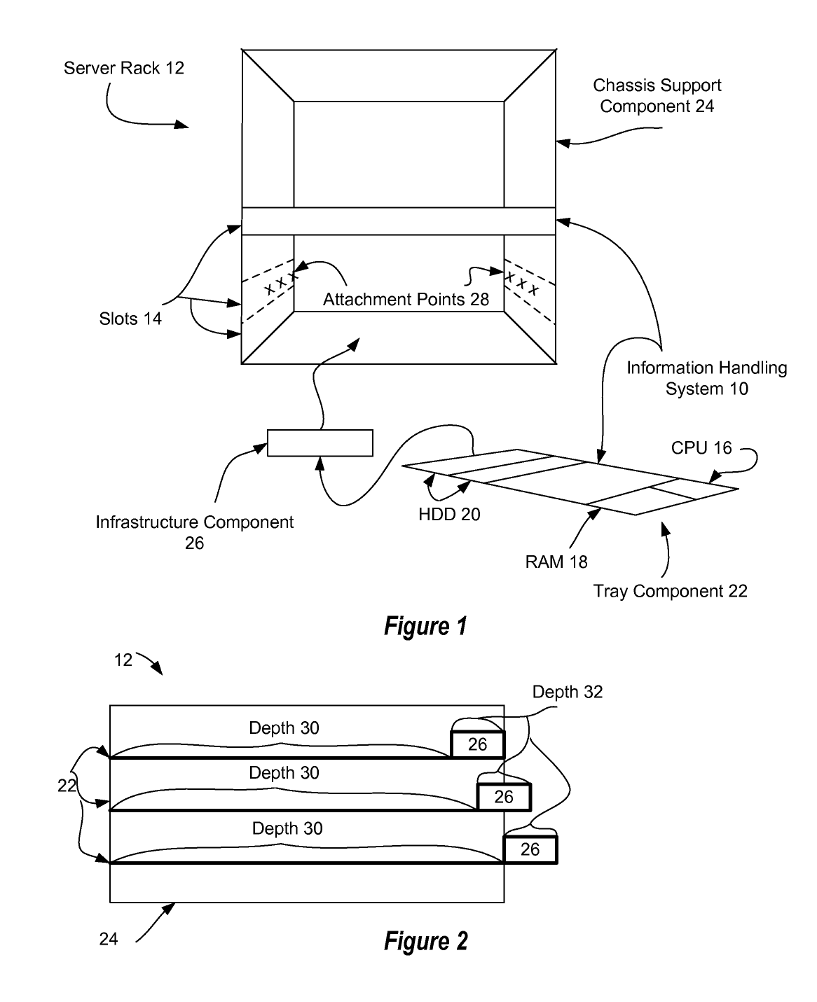

Referring now to FIG. 1, a front view depicts a server rack information handling system 12 that supports plural information handling systems 10 disposed in slots 14. Each slot 14 accepts an information handling system 10 that performs a data center function, such as a server function or a storage function. Information handling system 10 is built with plural processing components that cooperate to process information, such as a CPU 16, RAM 18 and a hard disk drive 20. Power, cooling, networking and other resources that support the operation of information handling system 10 are provided through rack 12.

Server rack information handling system 12 provides a data center solution with a shared infrastructure that supports a factory configurable depth. The solution breaks server rack information handling system 12 into three separable components: a tray component 22 that contains the processing components for performing the server and storage functions; a chassis support component that is essentially a large support shelf that holds plural tray components 22 in slots 14; and an infrastructure component 26 that provides infrastructure, such as power and cooling. The location of infrastructure component 26 is variable along the depth of slot 14 based upon the attachment point 28 where infrastructure component 26 attaches to chassis support component 24. The depth of the location of infrastructure component 26 may be set during manufacture of the chassis or after delivery to a data center. The depth of tray component 22 is set to fill the portion of slot 14 that remains available after infrastructure component 26 is installed. The capability of the processing components disposed on tray component 22 depends in part on the amount of room that is provided on tray component 22 after the position of infrastructure component 26 is established.

Referring now to FIG. 2, a side breakaway view depicts a server rack information handling system 12 that supports tray components 22 of different depths. When installed at a data center, the total depth of server rack information handling system 12 equals the depth 30 of tray component 22 plus the depth 32 of infrastructure component 26. FIG. 2 illustrates how the same chassis support component 24 can have several different depths depending upon the depth at which infrastructure component 26 is installed. By moving infrastructure component 26 in towards the interior of chassis support component 24, the total depth of rack 12 shrinks to allow rack 12 to fit into a data center with limited floor space. By moving infrastructure component 26 out of the interior or chassis support component 24, the depth of tray component 22 increases to provide additional room for processing components. In this manner, the same infrastructure component 26 supports multiple configurations of processing components on different sized tray components 22. Although FIG. 2 depicts different depth settings of infrastructure components 26 in a chassis support component, generally a chassis support component 24 will have all infrastructure components 26 at the same depth setting.

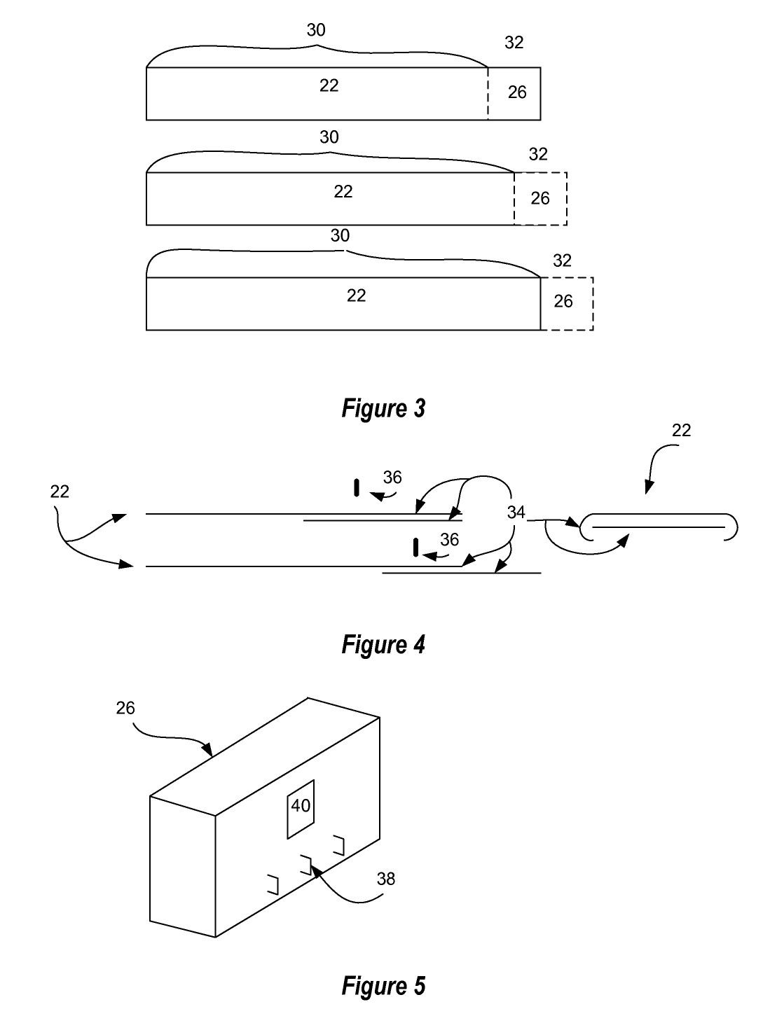

Referring now to FIG. 3, a top view is depicted of tray components 22 of different depths 30. The different depths of tray components 22 may be implemented in a number of ways. In one embodiment, tray component 22 is built to three different lengths with a length available for each desired depth. At manufacture, the end user selects a depth desired for information handling system rack 12 and then selects a chassis support component configurable to the desired depth. In an alternative embodiment, tray component 22 has a depth of the maximum configuration and infrastructure component 26 is placed to overlap tray component 22 when smaller depths are desired. In a third embodiment, tray component 22 is configurable to change depths as needed to fit in a chassis support component 24.

Referring now to FIG. 4, a tray component 22 is depicted having overlapping support bases 36 that slide relative to each other. Once a chassis support component 24 is selected and infrastructure component 26 location is set, overlapping support bases 34 are slid relative to each other to establish a desired depth for tray component 22. An attachment device, such as a screw 36, locks overlapping support bases 26 relative to each other so that processing components can be assembled in the selected space available based upon the relative location of overlapping support bases 34 to each other.

Referring now to FIG. 5, a side perspective view depicts an infrastructure component 26 that couples to chassis support component 24 at a position towards the rear of a slot 14. Infrastructure component 26 includes prongs 38 that interface tray component 22 with a passive power delivery backplane to power processing components. One or more cooling fans 40 may be included in infrastructure component 26 to provide a cooling airflow to the processing components. Other types of infrastructure support may also be included, such as networking interfaces, a fan controller, a baseboard management controller and a chassis manager. Design and manufacture of server rack information handling system 12 is simplified by having a common infrastructure component 26 to support information handling systems 10 on tray components 22 having different depths based upon the depth supported at a data center.

Although the present invention has been described in detail, it should be understood that various changes, substitutions and alterations can be made hereto without departing from the spirit and scope of the invention as defined by the appended claims.

What is claimed is:

1. An information handling system comprising:
a chassis support component having plural slots, each slot having a depth, each slot operable to support a tray component and an infrastructure component;
a tray component disposed in plural of the slots, the tray component operable to support processing components that cooperate to process information, the tray component selectable between plural depths to fit within the chassis support component depth;
an infrastructure component disposed in each of the plural of the slots, the infrastructure component operable to communicate power from the chassis support component to the processing components of the tray component.

2. The information handling system of claim 1 further comprising processing components disposed in the tray component, the processing components performing a server function.

3. The information handling system of claim 1 further comprising processing components disposed in the tray component, the processing components performing a storage function.

4. The information handling system of claim 1 wherein the tray component further comprises:
first and second overlapping support bases disposed to slide relative to each other to adjust between plural depths; and
a locking device operable to lock the first and second overlapping support bases in a position having the chassis support component depth.

5. The information handling system of claim 4 wherein the locking device comprises one or more screws.

6. The information handling system of claim 4 wherein the first overlapping support base has lips formed along parallel edges and the second overlapping support base slides in the lips.

7. The information handling system of claim 1 wherein the infrastructure component is further operable to provide cooling airflow to the tray component.

8. The information handling system of claim 1 wherein the chassis support component has a front and rear, and the infrastructure support component is disposed at the rear.

9. The information handling system of claim 8 wherein the tray support component depth is adjusted so that the tray support component is disposed from the chassis support component front to a position proximate the infrastructure component.

10. A method for manufacture of an information handling system, the method comprising:
selecting a chassis support component having a depth;
selecting a depth of a tray component to a selected of plural selectable depths, the selected depth fitting within the chassis support component;
assembling processing components in the tray component; and
installing the tray component into the chassis support component.

11. The method of claim 10 further comprising:
installing an infrastructure component in the chassis support component, the infrastructure component having a depth; and
providing power from the infrastructure component to the tray component.

12. The method of claim 11 wherein the chassis support component comprises plural slots, the tray component and infrastructure component installed in a common slot so that the tray component selected depth and the infrastructure component depth substantially equal the chassis support component depth.

13. The method of claim 12 wherein the processing components disposed in the tray component perform a server function.

14. The method of claim 12 wherein the processing components disposed in the tray component perform a storage function.

15. The method of claim 10 wherein selecting a depth of a tray component further comprises sliding first and second support bases relative to each other.

16. The method of claim 15 further comprising locking the first and second support bases in the selected depth with one or more screws.

17. The method of claim 10 wherein selecting a chassis support component further comprises selecting from plural chassis support components, each chassis support component having a depth, the selected depth fitting in a predetermined space of a data center.

18. An apparatus for adjusting the depth of an information handling system, the apparatus comprising:
a tray component operable to support processing components for processing information, the tray component selectable between plural depths; and
an infrastructure component operable to couple at an end of the tray component, the infrastructure component further operable to power the processing components.

19. The apparatus of claim 18 wherein the tray component is further operable to couple in a slot of a selected of plural chassis support components, each chassis support component having a depth.

20. The apparatus of claim 19 wherein the infrastructure component is further operable to provide a cooling airflow to the processing components.
